(19) United States
(12) Patent Application Publication
(10) Pub. No.: US 2016/0201850 A1
(43) Pub. Date: Jul. 14, 2016

(54) GAS CYLINDER FOR THE STORAGE AND DELIVERY OF P-TYPE DOPANT GASES

(71) Applicant: Matheson Tri-Gas, Basking Ridge, NJ (US)

(72) Inventor: Adam J. Seymour, Longmont, CO (US)

(73) Assignee: Matheson Tri-Gas, Basking Ridge, NJ (US)

(21) Appl. No.: 14/994,151

(22) Filed: Jan. 13, 2016

Related U.S. Application Data
(60) Provisional application No. 62/103,373, filed on Jan. 14, 2015.

(51) Int. Cl. F17C 1/10; F17C 5/06

(52) U.S. Cl. CPC F17C 1/10; F17C 5/06; F17C 2201/0114; F17C 2201/0109; F17C 2203/0604; F17C 2203/0619; F17C 2203/0639; F17C 2203/0648; F17C 2221/037; F17C 2260/053; F17C 2270/0518

(57) ABSTRACT

A corrosion resistant gas cylinder includes an electroless nickel-boron layer overlying the inner surface of a steel alloy cylinder. The nickel-boron layer has a thickness of at least about 20 micrometers and a porosity of no greater than about 0.1%. The electroless nickel-boron layer has a boron content of at least about 1% by weight and a surface roughness of no greater than about 5 micrometers. Prior to introducing liquefied gas into the gas cylinder, a cleaning process is carried out using a two-step baking process to clean the surface of the nickel-boron layer. The nickel-boron layer substantially reduces the contamination of liquefied corrosive gases stored in the gas cylinder by metal from the steel wall surface underlying the nickel-boron layer. Metal contamination levels of less than about 55 ppb of iron, 10 ppb of chromium, and 5 ppb of nickel by weight can be maintained in liquefied corrosive gases stored for an extended period of time in the electroless nickel-boron plated gas cylinder.

### CROSS REFERENCE TO OTHER APPLICATIONS

This application claims benefit of priority to U.S. Provisional Application No. 62/103,373, filed Jan. 14, 2015, the disclosure of which is fully incorporated herein by reference.

### BACKGROUND OF THE INVENTION

1. Field of the Invention

The present invention relates, in general, to high pressure gas delivery systems and containment vessels, and more particularly, to gas delivery systems and containment vessels, such as a gas cylinder, for the delivery of high-purity, reactive, vapor phase, and liquefied gases.

2. Description of the State of the Art

Systems for the delivery of high-purity, reactive, vapor, and liquefied gases are an important component in a variety of manufacturing industries. For example, a reliable supply of ultra, high-purity electronic specialty gases is critical to maintaining productivity and manufacturing yield in the semiconductor industry. The delivery of corrosive, liquefied gases can be problematic, because of the highly corrosive and reactive nature of these gases. In addition some dopant materials such as diborane (B₂H₆) and boron precursors as well as phosphine and arsine can be unstable in standard carbon steel packages. Halogenated gases, such as boron trichloride (BCl₃), hydrogen chloride (HCl), and the like, can hydrolyze in the presence of moisture and react with the metal surfaces of containment vessels and gas supply lines. Any gas-surface reactions taking place within the gas delivery system can produce unwanted particulate contamination as well as unwanted by-products that result in contamination of the original material.

The demand for ultra-high purity gases in the electronics industry, requires that suppliers provide gas delivery systems and containment vessels that are capable of remaining nonreactive with the contained gases over many product refill cycles. Gas cylinders are widely used to delivery high-pressure gases in a safe and controlled manner. Typically, gas cylinders are constructed of low-carbon steel. However, to attain the required purity levels and service life demanded in the electronics industry, low-carbon steel cylinders require special materials of construction, or additional treatments, to minimize metal contamination from the cylinder walls. To maintain high purity levels for the storage of specialty gases, the internal surfaces of steel cylinders are polished and baked to remove contaminants and residual moisture. For example, it is known to perform a vacuum baking process of an electro-polished carbon steel cylinder. The electropolishing process is carried out with a chromium-rich electroplating solution to provide a surface layer with reduced iron and increased carbon and chromium.

While the electropolishing and vacuum baking of gas cylinders can be sufficient to avoid metal contamination in non-corrosive gases, such as nitrogen, the storage of highly corrosive gas requires more extensive cylinder preparation procedures to reduce metal contamination. To combat the metal contamination problem in corrosive gas delivery systems, an electroplated nickel layer can be formed on the internal surfaces of a steel cylinder. For example, it is known to provide a gas cylinder having an electroplated nickel lining. Since nickel is substantially nonreactive with corrosive gases, such as BCl₃, HCl, and the like, nickel represents a preferred material of construction for corrosive gas cylinders. Because nickel has a very low reaction rate with halogenated gases, cylinder walls of nickel can provide the required low metal contamination levels needed by the semiconductor industry. It is also known to provide a gas cylinder having an electroless nickel-phosphorous lining; however, nickel-phosphorous does not result in a robust adhesion result. In addition NiP provides a possible source of N type dopants for gases that are significantly sensitive to N-type contamination such as BF₃, BCl₃, and B₂H₆. In addition nickel phosphorous coatings tend to be brittle (glass-like) with elongation of <1%, have poor adhesion to steel, and contain pin holes in the coating that allows the contents of the container to come into contact with the steel substrate.

Although nickel coated steel cylinders offer advantages in gas delivery systems supplying corrosive gas, it is often difficult to obtain a high-quality nickel lining. For example, nickel plating can have cracks, and voids exposing the underlying steel cylinder surface. Additionally, conventional nickel plating can result in a rough surface topography that can trap contaminants. Although electroplated nickel avoids many of the problems encountered by conventionally plated nickel, high-quality electroplated nickel is obtained by application of a nickel coating at a point in the cylinder manufacturing process before the cylinder neck is formed. This is necessary to allow electrodes to be placed correctly inside the cylinder. The cumbersomeness of the nickel electroplating process drives up manufacturing costs and increases the amount of time necessary to fabricate a gas cylinder. Additionally, to ensure that cracks and voids are not formed, the electroplating process is extended for a period of time long enough to deposit a 250-500 micrometer thick layer of nickel.

Because of the inherent difficulty in electroplating a nickel layer to the inner surfaces of a previously formed cylinder, processes have been developed to electroplate the nickel layer prior to the drawing process used to form the cylinder. While avoiding the difficulty of arranging electrodes within a previously drawn cylinder, the steel sheet electroplating process requires the application of additional treatments, such as lubricant application and additional processing to relieve the plating stress induced in electroplated nickel.

Nickel, including nickel-phosphorous, coated gas cylinders remain a viable means for achieving the low metal contamination levels demanded by the electronics industry. However, present nickel-coated gas cylinders can only be obtained by relatively expensive, complex manufacturing processes. Additionally, existing nickel-coated cylinders often exhibit non-uniform nickel layers in which bare steel surfaces are exposed. While nickel-phosphorous coated cylinders address some of the above mentioned short-comings, the nickel-phosphorous coatings lack sufficient mechanical properties, such as, but not limited to, adhesion. Accordingly, an improved gas cylinder and delivery system is needed to ensure low metal contamination in gas delivery systems used for handling corrosive electronic specialty gases.

### BRIEF SUMMARY OF THE INVENTION

The present invention is for high-pressure steel gas cylinders having an electroless nickel-boron layer overlying the inner surface of the cylinder. Boron has a very low solubility in solid nickel and there are several line compounds in the nickel-boron system, such as Ni₃B, Ni₂B, Ni₄B₃ and NiB. The electroless nickel-boron coating is based on the formation of metalloid alloy formed on a metal such as the interior surface of a steel cylinder by spontaneous reduction of metallic slats in aqueous solution. This reaction occurs due to the oxidation of a chemical reagent (the reducer) such as a borohydride ion, such as but not limited to sodium borohydride or an aminoborane compound such as but not limited to dimethylaminoborane (DMAB). The electroless nickel-boron layer passivates the steel surface by forming a strongly bonded, low-porosity surface layer that resists undercutting and has a consistent thickness. In addition to exhibiting a uniform thickness, the electroless nickel-boron layer has a smooth surface topography, which mimics the underlying steel surface. Additionally, the electroless nickel-boron layer is substantially thermodynamically stable in corrosive environments. The electroless nickel-boron layer has a relatively and low corrosion potential, when compared to nonpassivated 316 and 304 stainless steel. The relative nonreactivity of the electroless nickel-boron renders the material approximately a noble metal similar in nonreactiveness to Hastelloy B and C series alloys in an aqueous halide environment.

In addition to exhibiting good morphologic characteristics, the electroless nickel-boron plating process can be carried out after the steel cylinder has been completely drawn and threaded. After completing the plating process is complete, a cleaning process to be carried out to clean the surface of the nickel-boron layer in preparation for charging the cylinder with liquefied gas.

In one form, a high-pressure gas cylinder formed in accordance with the invention includes a cylinder wall having an inner surface. A nickel-boron layer overlies the inner surface of the cylinder. The nickel-boron layer has a thickness of at least about 20 micrometers and a porosity no greater than about 0.10% and a surface roughness of no greater than about 10 micrometers on average. The electroless nickel-boron layer is subjected to an acid wash and a hot deionized water washing, followed by a first bake under continuous nitrous flow and a second bake under vacuum pressure.

Additional embodiments and features are set forth in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### BRIEF DESCRIPTION OF THE DRAWINGS

A further understanding of the nature and advantages of the disclosed embodiments may be realized by reference to the remaining portions of the specification and the drawings.

FIG. 1 is a schematic diagram of a gas delivery system arranged in accordance with one embodiment of the invention;

FIG. 2 is a cross-sectional view of a gas cylinder arranged in accordance with the invention;

FIG. 3 is a cross-sectional view of a ton-cylinder arranged in accordance with the invention;

In the appended figures, similar components and/or features may have the same reference label. Further, various components of the same type may be distinguished by following the reference label by a dash and a second label that distinguishes among the similar components. If only the first reference label is listed in the specification, the description is applicable to anyone of the similar components having the same first reference label irrespective of the second reference label.

### DETAILED DESCRIPTION OF THE INVENTION

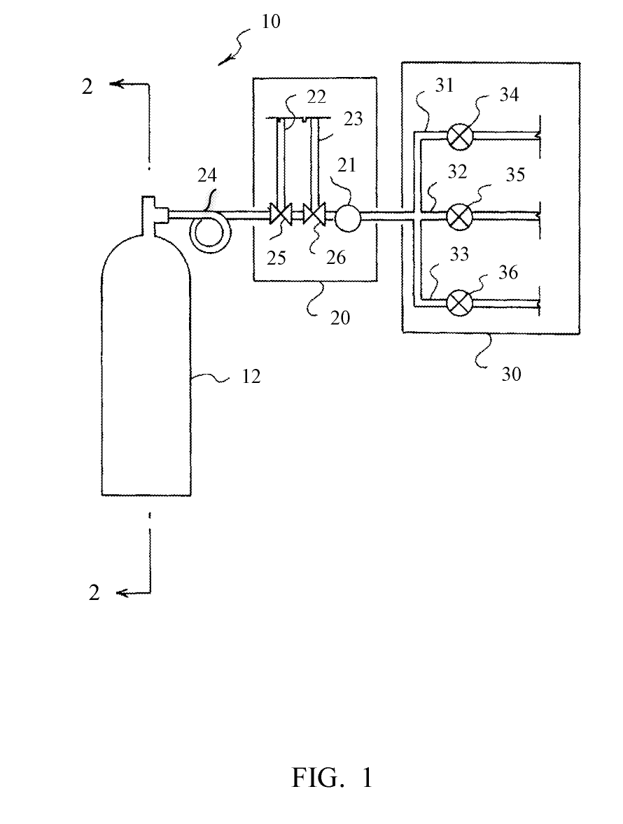

Shown in FIG. 1 is a schematic diagram of a gas delivery system 10 configured for the delivery of high-purity, corrosive gases to semiconductor processing equipment (not shown). Gas delivery system 10 includes a gas cylinder 12 coupled to a gas panel 20 and to a gas manifold enclosed in a valve manifold box (VMB) 30. A regulator 21 controls the gas pressure in gas delivery system 10. In gas panel 20, a nitrogen purge line 22 and a vacuum line 23 are connected to a source gas line 24 through valves 25 and 26, respectively. In VMB 30, individual lines 31, 32, and 33 can be directed to one or more pieces of manufacturing equipment. Mass flow controllers 34, 35, and 36 regulate the flow of gas to the processing equipment from gas lines 31, 32, and 33, respectively.

The delivery of high-purity, reactive, corrosive or unstable gases by gas delivery system 10 requires that all interior surfaces exposed to the reactive, corrosive, or unstable gas be relatively nonreactive. In accordance with the invention, the internal surfaces of at least gas cylinder 12 are coated with an electroless nickel-boron layer having a thickness of at least about 20 micrometers.

Those skilled in the art will recognize gas delivery system 10 to be one possible configuration of a gas delivery system suitable for delivery of reactive, corrosive, or unstable gases to electronics industry processing equipment. Although a typical configuration is illustrated, various modifications of the design illustrated in FIG. 1 can be provided and are within the scope of the present invention. For example, more than one gas cylinder can be coupled to gas VMB 30, or larger vessels, such as ton-cylinders or tube trailers can be coupled to VMB 30. Further, gas panel 20 can have a wide variety of configurations which will be understood by those skilled in the art. Moreover, gas manifold 30 itself can have a wide variety of configurations, including multiple individual gas lines and additional mass flow controllers. Gas delivery system 10 can supply P-type dopant gases, such as but not limited to, boron chloride (BCl₃), diborane (B₂H₆), higher boranes (BₓH_{y}, where x and y are greater than 2), boron trifluoride (BF₃), aluminum (Al), gallium (Ga), indium (In), and titanium (Ti) precursors. In addition, etchants of P-type layers would be compatible to further reduce the possibility of N-type contamination of a P-type layer, such as but not limited to chlorine (Cl₂), hydrogen bromide (HBO, boron chloride (BCl₃), hydrogen chloride (HCl), and the like, to one or more pieces of etching equipment at a relatively high pressure. In one embodiment, gas cylinder 12 is charged with about 100 lbs of a liquefied etching gas, such as HCl, HBr, BCl₃, HCl, Cl₂ and the like, and delivers the etching gas to an etching machine at a suitable flow rate and having a metal concentration of no more than about 200 parts-per-billion (ppb), and preferably no more than about 100 ppb. In a preferred embodiment the liquefied etching gases are obtained by a controlled differential pressure vapor transfer method. These gases are all commercially available from Matheson Tri-Gas. The gas production process yields gases of high-purity typically having metal contaminants such as iron, chromium, and nickel at a concentration of less than about 100 ppb by weight. Alternatively, gas cylinder 12 is charged with about 100 lbs. of a liquefied P-type dopant gas, such as boron chloride (BCl₃), diborane (B₂H₆), higher boranes, boron trifluoride (BF₃), aluminum (Al), gallium (Ga), indium (In), and titanium (Ti) precursors and the like, and delivered to a deposition chamber at a suitable flow rate and having a metal concentration of no more than about 200 parts-per-billion (ppb), and preferably no more than about 100 ppb.

The low metal contaminant levels obtained from gas delivery system 10 are achieved, in part, by coating the internal metal surfaces of gas cylinder 12 with an electroless nickel-boron coating, such as but not limited to nickel boride (NiB), Ni₃B, Ni₂B, and Ni₄B₃ having a thickness of preferably at least about 20 micrometers, and more preferably having a thickness of about 20 to 50 micrometers, and most preferably having a thickness of about 25 micrometers.

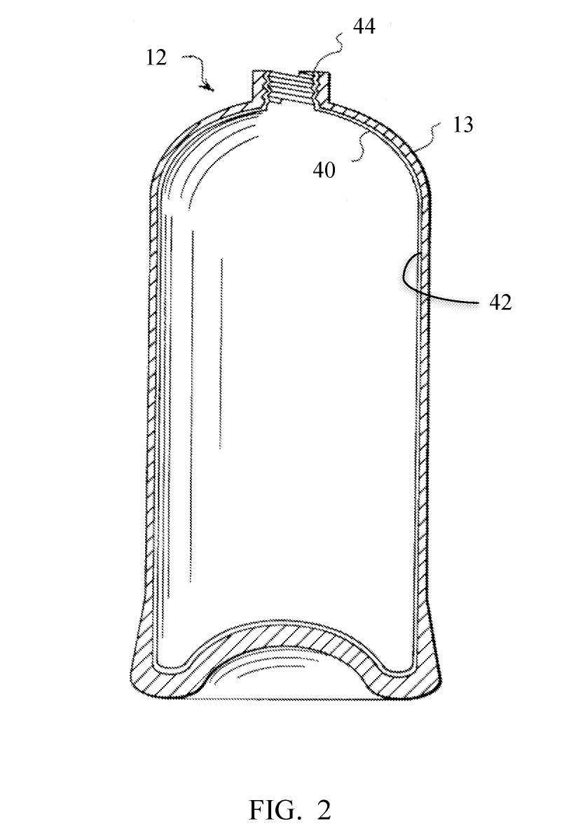

FIG. 2 illustrates a cross-sectional view of gas cylinder 12 taken along section line 2-2 of FIG. 1. In a preferred embodiment of the invention, a continuous nickel-boron layer 40 overlies an inner surface 42 of a tank wall 13. Nickel-boron layer 40 is formed by an electroless plating process, in which the nickel-boron is deposited to a thickness of preferably at least about 20 micrometers, and more preferably to a thickness of about 20 to about 100 micrometers, and most preferably to a thickness of about 50 micrometers Additionally, nickel-boron layer 30 has a porosity of no greater than about 0.5%, and preferably no greater than about 0.1%, and most preferably no greater than about 0.02%. Since low porosity is an important factor in obtaining low metal concentrations in liquefied corrosive gases, ideally, the porosity of nickel-boron layer 40 should be as low as possible. Gas cylinder 12 has a threaded opening 44 for insertion of a gas valve. The threads can be located on either the inner surface or the outer surface of opening 44.

The formation of nickel-boron layer 40 to a uniform thickness and a low porosity creates a chemically passive barrier that reduces metal dissolution from inner surface 42 into the liquefied gas contained within gas cylinder 12. Typically, gas cylinders, such as gas cylinder 12, are constructed from steel listed in USDOT Specification 3AA, 110A1000W, 106A500W, and 4BW260 such as Types 4130, NE8630, 9115, 9125, carbon-boron steel, intermediate-manganese steel, and the like. In a preferred embodiment of the invention, gas cylinder 12 is constructed of Type 4130 steel, or alternatively, intermediate-manganese steel. Accordingly, the metal contaminants that must be reduced in order to provide high-purity gas for electronics applications are those typically found in the previously described steel alloys. By forming nickel-boron layer 40 to the parameters described above, metal contaminants, such as iron (Fe), chromium (Cr), nickel (Ni), and the like are substantially reduced in gas stored in gas cylinder 12. Other metal contaminants originating from inner surface 42 can include copper (Cu), boron (P), arsenic (As), cadmium (Cd), sodium (Na), lead (Pb), tin (Sn), zinc (Zn), and the like.

By forming a nickel-boron layer on inner surface 42 having a thickness of at least about 20 micrometers and a porosity of no greater than about 0.1%, and preferably no greater than about 0.02%, high-purity corrosive gases can be stored in and delivered by gas delivery system 10 that contain an Fe concentration of preferably no greater than about 100 ppb, and more preferably, no greater than about 60 ppb, and most preferably, no greater than about 55 ppb by weight. Additionally, high-purity gases can be stored and delivered that have a Cr concentration of preferably no greater than about 100 ppb, and more preferably, no greater than about 90 ppb, and most preferably, no greater than about 10 ppb by weight, and a Ni concentration of no greater than about 100 ppb, and more preferably, no greater than about 40 ppb, and most preferably, no greater than about 25 ppb by weight. Furthermore, high-purity corrosive gases can be stored and delivered by gas cylinder 12 that contain no greater than about 20 ppb by weight of Cu, P, As, Cd, Na, Pb, Sn, Fn, and the like.

In addition to having a uniform thickness and low porosity, nickel-boron layer 40 has a surface roughness of preferably no more than about 10 micrometers, and more preferably no greater than about 5 micrometer Ra. In an electroless nickel-boron layer formed in accordance with the invention, the surface roughness varies from about 0.33 micrometers to about 4.62 micrometers Ra.

In the electroless plating process used to form nickel-boron layer 40, the process parameters can be adjusted to deposit a nickel-boron layer having a relatively wide compositional range. For example, the electroless plating process can deposit a nickel-boron layer having a boron concentration ranging from about 0.1% by weight to about 7% by weight. Preferably, nickel-boron layer 40 is a mid-boron layer having a boron concentration of at least about 3-5% by weight boron. In addition to nickel and boron, nickel-boron layer 40 can contain trace amounts of other elements, such as boron, salvation agents, pH adjusting agents, reducing agents, chelating agents, stabilizers, and the like.

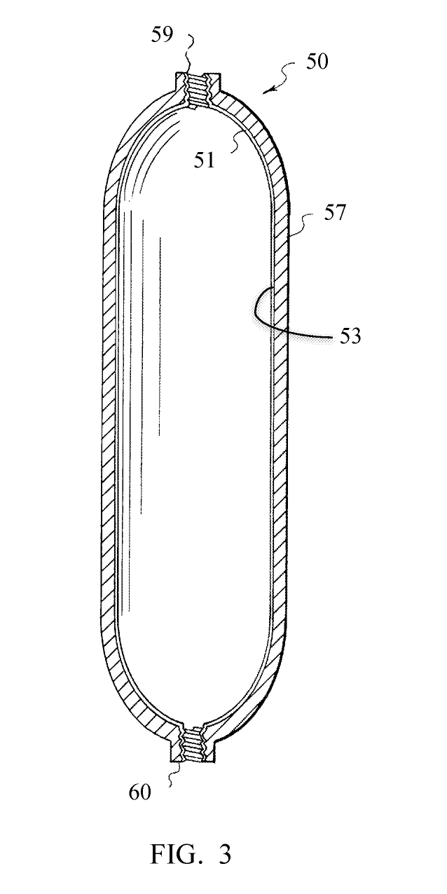

FIG. 3 illustrates a cross-sectional view of a double-ended ton cylinder 50. Ton cylinder 50 is used for the storage of large quantities of gas and can be one of a number of such cylinders positioned on a tube trailer. Ton cylinder 50 has a diameter of about 2 feet and a length of about 6.5 feet and can hold about 600 lbs. of liquefied gas.

In accordance with the invention, a nickel-boron layer 51 overlies an inner surface 53 of a tank wall 57 of ton cylinder 50. Nickel-boron layer 51 has a thickness and porosity similar to layer 40 in gas cylinder 12. To facilitate the removal of liquefied gas, ton cylinder 50 has a first threaded opening 59 opposite a second threaded opening 60. The threads can be located on either the inner surface or the outer surface of openings 59 and 60.

Those skilled in the art will recognize that other types of gas cylinders, including tanker-sized gas containers can be coated with an electroless nickel-boron coating. It is contemplated by the present invention that all such cylinder sizes and designs be used in gas delivery system 10.

It is understood that the following process description applies to both gas cylinder 12 and ton cylinder 50. Those skilled in the art will appreciate that the following electroless plating and cleaning process can apply to a wide variety of gas cylinders.

To prepare gas cylinder 12 for electroless plating, cylinder 12 is mechanically polished using glass beads or steel grit in a the slurry mixture, while rotating the cylinder at about 60 revolutions-per-minute (rpm). The mechanical polishing process smoothes inner surface 42 and removes dirt and debris, steel burs, and the like, from inner surface 42. After completion of the mechanical polishing process, the glass beads or steel grit and the slurry mixture are removed, and the cylinder is rinsed with water.

In order to improve the adhesion of nickel-boron layer 40 to steel inner surface 42, an acidic solution, preferably hydrochloric acid, is applied to surface 42. The hydrochloric acid solution can vary from about 10 to about 50% by volume. Additionally, sulfuric acid can be used varying from about 2 to about 10% by volume. Preferably, a 40% by volume hydrochloric acid solution is used to activate inner surface 42. Activation is important to initiate the autocatalytic reaction necessary for the electroless plating process. In addition, alkaline deoxidizers containing organic chelating agents, or sodium cyanide, or both, can also be used to remove oxides from inner surface 42 prior to activation.

Following surface preparation, gas cylinder 12 is directly placed in a vertical tank filled with water. A commercially available polypropylene tank holds the electroless nickel-boron plating solution. The plating solution is pumped from the polypropylene tank through a filter to reduce particulates in the bath solution and into the cylinder standing in the vertical tank. Another tube allows the plating solution to flow out of the cylinder and back into the polypropylene tank.

The plating process is carried out in the bath, and the bath preferably contains a nickel source, such as but not limited to nickel chloride hexahydrate (NiCl₂.6 H₂O), a reducer, such as but not limited to sodium borohydride (NaBH₄), a complexing agent, such as but not limited to ethylene diamine (NH₂—CH₂—CH₂—NH₂), a stabilizer, such as but not limited lead tungstate (PbWO₄) and buffers. The bath is preferably operated at a temperature of about 70° C. to about 99° C. and the pH is maintained within a range of about 4 to 5. The deposition thickness is controlled by the residence time of gas cylinder 12 in the plating bath. The actual residence time necessary to deposit nickel-boron layer 40 to the preferred thickness ranges set forth above depends upon the particular deposition rate of the plating bath. In a typical plating process carried out in accordance with the parameters above, a plating rate of about 7 to about 25 micrometers per hour can be achieved.

After completing the plating process, gas cylinder 12 is subjected to an acid detergent wash in “Oakite” solution for about 10 minutes to about 20 minutes, and more preferably about 15 minutes, followed by a deionized water rinse. Oakite is a phosphoric acid and detergent mixture available from Oakite Products, Inc. Next, gas cylinder 12 is washed for about 10 minutes to about 18 minutes, and more preferably about 15 minutes with hot deionized water having a temperature of about 50° C. to about 65° C., and more preferably about 60° C. and a resistance of about 16 megaohms. Gas cylinder 12 is then dried with filtered nitrogen and baked. A purge tube is inserted into gas cylinder 12 and a flow of filtered nitrogen is maintained during the baking process. The process is carried out for about 1 hour at about 189° C. to about 210° C., and more preferably about 200° C.

Once the baking process is complete, a tied-diaphragm-type valve is inserted into gas cylinder 12, and a vacuum baking process is carried out at about 390° C. to about 410° C., and more preferably about 400° C. a neutral atmosphere (95% Ar+5% H₂) and at a vacuum pressure of about 20 microns to about 50 microns, and more preferably, about 20 microns, and for about 1 hour.

Upon completion of the nickel-boron electroless plating and cleaning process, gas cylinder 12 can be charged with a wide variety of corrosive liquefied gases used by the electronics industry. Importantly, gas cylinder 12 can be charged with P-types dopant gases such as but not limited to, boron chloride (BCl₃), diborane (B₂H₆), boron trifluoride (BF₃), aluminum (Al), gallium (Ga), indium (In), and titanium (Ti) precursors or corrosive liquefied gases, such as but not limited to HCl₂, Cl₂, BCl₃, HBr, and the like.

Without further elaboration it is believed that one skilled in the art can, using the description set forth above, utilize the invention to its fullest extent.

Having disclosed several embodiments, it will be recognized by those of skill in the art that various modifications, alternative constructions, and equivalents may be used without departing from the spirit of the disclosed embodiments. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the dielectric material” includes reference to one or more dielectric materials and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A high-pressure steel gas cylinder for the containment of P-type dopant gases comprising:
a cylinder wall having an inner surface; and
an electroless nickel-boron layer overlying said inner surface wherein said electroless nickel-boron layer has a thickness of at least about 20 micrometers, a porosity of no greater than about 0.1%, and a surface roughness of no greater than about 10 micrometers wherein the electroless nickel-boron layer is subjected to an acid wash and a hot deionized water wash, followed by a first bake under continuous nitrogen flow and a second bake under vacuum pressure wherein high-pressure gas cylinder is charged with a P-type dopant gases.

2. The gas cylinder of claim 1, wherein said electroless nickel-boron layer comprises a nickel-boron layer having a thickness of about 20 to about 50 micrometers.

3. The gas cylinder of claim 2, wherein said electroless nickel-boron layer comprises nickel boride.

4. The gas cylinder of claim 1, wherein said electroless nickel-boron layer comprises a nickel-boron layer having a porosity of no greater than about 0.05%.

5. The gas cylinder of claim 4, wherein said electroless nickel-boron layer comprises a nickel-boron layer having a porosity of no greater than about 0.01%.

6. The gas cylinder of claim 1, wherein said electroless nickel-boron layer comprises a nickel-boron layer having a surface roughness of no greater than about 3 micrometers.

7. The gas cylinder of claim 1, wherein said cylinder wall comprises low-carbon polished steel.

8. The gas cylinder of claim 1, wherein said electroless nickel-boron layer comprises a nickel-boron layer having at least about 1 wt. % boron.

9. The gas cylinder of claim 1, wherein said P-type dopant gas is selected from the group consisting of boron chloride (BCl₃), diborane (B₂H₆), higher boranes (BₓH_{y}, where x and y are greater than 2), boron trifluoride (BF₃), aluminum (Al), gallium (Ga), indium (In), and titanium (Ti) precursors.

10. A method of storing a P-type dopant gas comprising:
preparing a high pressure gas cylinder having an inside wall and an outside wall;
plating the inside wall of said high-pressure gas cylinder with a nickel-boride layer;
charging said high-pressure gas cylinder with a P-type gas dopant.

11. The method of claim 11, wherein said nickel-boride layer formed on said inside wall of said high pressure gas cylinder has a thickness of at least about 20 micrometers and a porosity of about 0.1 to about 0.15% and a surface roughness of no greater than about 5 micrometers.

12. The method of claim 10, wherein said nickel-boride layer comprises at least about 1 wt % boride.

13. The method of claim 10, wherein said nickel-boride layer has a surface roughness of no greater than about 3 micrometers.

14. The method of claim 10, wherein said cylinder wall comprises low-carbon, polished steel.

15. The method of claim 10, wherein said nickel-boride layer has a thickness of about 20 to about 50 micrometers.

16. The method of claim 10, wherein said P-type dopant gas is selected from the group consisting of boron chloride (BCl₃), diborane (B₂H₆), higher boranes (BₓH_{y}, where x and y are greater than 2), boron trifluoride (BF₃), aluminum (Al), gallium (Ga), indium (In), and titanium (Ti) precursors.
